(19) United States
(12) Patent Application Publication
(10) Pub. No.: US 2017/0116417 A1
(43) Pub. Date: Apr. 27, 2017

(54) APPARATUS AND METHOD FOR DETECTING MALICIOUS CODE

(71) Applicant: SAMSUNG SDS CO., LTD., Seoul (KR)

(72) Inventors: Yoon-Chan JHI, Seoul (KR); Sung-Jin HWANG, Seoul (KR)

(73) Assignee: SAMSUNG SDS CO., LTD., Seoul (KR)

(21) Appl. No.: 15/333,849

(22) Filed: Oct. 25, 2016

(30) Foreign Application Priority Data
Oct. 26, 2015 (KR) 10-2015-0148943

(51) Int. Cl. G06F 21/56; G06F 21/55

(52) U.S. Cl. CPC G06F 21/564; G06F 21/554; G06F 2221/034

(57) ABSTRACT

Provided are an apparatus and method for detecting a malicious code. The method for detecting a malicious code includes detecting a call of one or more Application Program Interfaces (APIs) included in a monitoring group, acquiring a memory address of a caller of the detected call of the API, checking an attribute of a memory region corresponding to the acquired memory address, and determining whether a code written in the memory region is a malicious code based on the attribute.

### CROSS-REFERENCE TO RELATED APPLICATION

This application claims priority to and the benefit of Korean Patent Application No. 10-2015-0148943, filed on Oct. 26, 2015, the disclosure of which is incorporated herein by reference in its entirety.

### BACKGROUND

1. Technical Field

Embodiments of the present disclosure relate to an apparatus and method for detecting a malicious code of a computer.

2. Discussion of Related Art

An exploit represents a set of instructions that takes advantage of a software or hardware bug or a vulnerability generated during programming to execute an operation or a command intended by an attacker, or an attacking behavior using a set of instructions.

To respond to such an exploit attack, a general network security system is configured to use a signature of a known exploit code to detect an exploit attack. However, a method of detecting an exploit attack using a signature has difficulty in being applied to an unknown code whose signature does not exist. In particular, since an exploit code by nature comes in a large variety of types, a method of precisely detecting an exploit code is required.

### SUMMARY

Embodiments of the present disclosure provide an apparatus and method for detecting a malicious code by tracking a memory region in which a code is executed.

The technical objectives of the present disclosure are not limited to the above disclosure; other objectives may become apparent to those of ordinary skill in the art based on the following descriptions.

According to an aspect of the present disclosure, there is provided a method for detecting a malicious code, the method including: detecting a call of one or more Application Program Interfaces (APIs) included in a monitoring group; acquiring a memory address of a caller of the detected call of the API; checking an attribute of a memory region corresponding to the acquired memory address; and determining whether a code written in the memory region is a malicious code based on the attribute.

The acquiring of the memory address may acquire the memory address of the caller by using a return address of a call stack associated with the call.

The acquiring of the memory address may further include, when one or more higher callers corresponding to the caller exist in the call stack, acquiring a memory address of each of the one or more higher callers.

The attribute may include a type and a protection attribute of the memory region.

In the determining, the code may be determined to be a malicious code when the type of the memory region is an execution type (PAGE_EXECUTE*) and the protection attribute of the memory region is private (MEM_PRIVATE).

In the determining, the type of the memory region may be determined to be the execution type when the type of the memory region is one of PAGE_EXECUTE, PAGE_EXECUTE_READ, PAGE_EXECUTE_READWRITE, and PAGE_EXECUTE_WRITECOPY.

According to another aspect of the present disclosure, there is provided an apparatus for detecting a malicious code, the apparatus including a monitor, a memory address acquirer, a memory attribute checker, and a determiner. The monitor may be configured to detect a call of one or more Application Program Interfaces (APIs) included in a monitoring group. The memory address acquirer may be configured to acquire a memory address of a caller of the detected call of the API. The memory attribute checker may be configured to check an attribute of a memory region corresponding to the acquired memory address. The determiner may be configured to determine whether a code written in the memory region is a malicious code based on the attribute.

The memory address acquirer may be configured to acquire the memory address of the caller by using a return address of a call stack associated with the call.

The memory address acquirer may be configured to, when one or more higher callers corresponding to the caller exist in the call stack, acquire a memory address of each of the one or more higher callers.

The attribute may include a type and a protection attribute of the memory region.

The determiner may be configured to determine the code to be a malicious code when the type of the memory region is an execution type (PAGE_EXECUTE*) and the protection attribute of the memory region is private (MEM_PRIVATE).

The determiner may be configured to determine the type of the memory region to be the execution type when the type of the memory region is one of PAGE_EXECUTE, PAGE_EXECUTE_READ, PAGE_EXECUTE_READWRITE, and PAGE_EXECUTE_WRITECOPY.

According to another aspect of the present disclosure, there is provided a computer program stored in a computer readable recording medium in combination with hardware to execute steps including: detecting a call of one or more Application Program Interfaces (APIs) included in a monitoring group; acquiring a memory address of a caller of the detected call of the API; checking an attribute of a memory region corresponding to the acquired memory address; and determining whether a code written in the memory region is a malicious code based on the attribute.

### BRIEF DESCRIPTION OF THE DRAWINGS

The above and other objects, features and advantages of the present disclosure will become more apparent to those of ordinary skill in the art by describing exemplary embodiments thereof in detail with reference to the accompanying drawings, in which:

FIG. 1 is a block diagram of an apparatus for detecting a malicious code detecting apparatus according to one embodiment of the present disclosure; and

FIG. 2 is a flowchart illustrating a method for detecting a malicious code according to one embodiment of the present disclosure.

### DETAILED DESCRIPTION OF EXEMPLARY EMBODIMENTS

Hereinafter, exemplary embodiments of the present disclosure will be described in detail with reference to the accompanying drawings, and the following description is intended to aid in the understanding of the method, apparatus, and/or the system described in the specification but is illustrative in purpose only and is not to be construed as limiting the present disclosure.

In the description of the embodiments, the detailed description of related known functions or constructions will be omitted herein to avoid obscuring the subject matter of the present disclosure. In addition, terms which will be described below are defined in consideration of functions in the embodiments of the present disclosure, and may vary with an intention of a user and an operator or a custom. Accordingly, the definition of the terms should be determined based on the overall content of the specification. It should be understood that the terms used in the specification and the appended claims are not to be construed as limited to general and dictionary meanings, but should be interpreted based on meanings and concepts corresponding to technical aspects of the present disclosure on the basis of the principle that the inventor is allowed to define terms appropriately for the best explanation. As used herein, the singular forms “a,” “an,” and “the” are intended to include the plural forms as well unless clearly indicated otherwise by context. It should be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

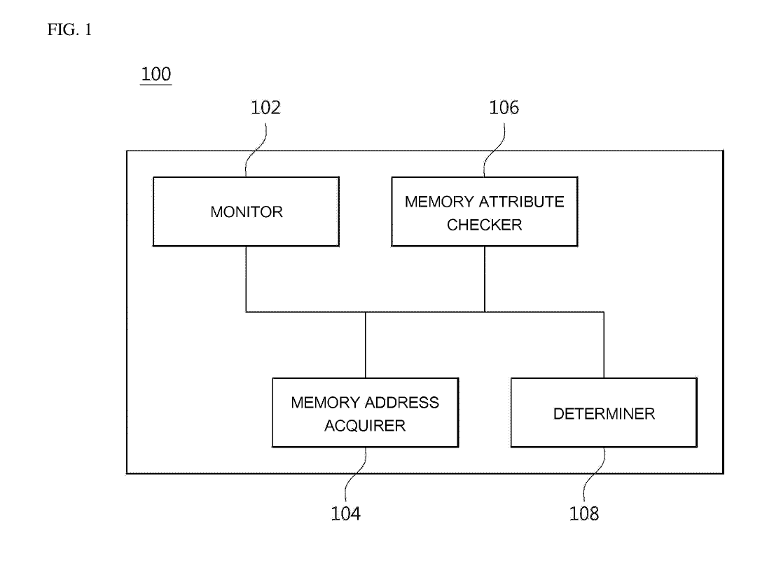

FIG. 1 is a block diagram of an apparatus for detecting a malicious code according to one embodiment of the present disclosure. Referring to FIG. 1, an apparatus 100 for detecting a malicious code according to an embodiment of the present disclosure includes a monitor 102, a memory address acquirer 104, a memory attribute checker 106, and a determiner 108.

The monitor 102 detects a call of one or more Application Program Interfaces (APIs) included in a monitoring group. The monitoring group is a set of APIs generally used by an exploit attack code, which mainly includes APIs related to execution of a program or a processor. The following is an example of types of APIs included in a monitoring group.
WinExec
CreateProcessW
CreateProcessA
CreateProcessInternalW
CreateProcessInternalA
ShellExecuteW
ShellExecuteA
ShellExecuteExW
ShellExecuteExA

According to one embodiment of the present disclosure, the monitor 102 may detect a call of any one of the APIs included in the monitoring group by using an API hooking technique and the like. API hooking represents a technique of gaining control by intercepting an API call of an application.

The memory address acquirer 104 acquires a memory address of a caller of the call of the API detected by the monitor 102. According to one embodiment of the present disclosure, the memory address acquirer 104 may acquire a memory address of the caller by using a return address of a call stack associated with the call. A call stack represents a stack data structure which stores information about a computer program code that will be executed in an application. For example, when an application calls a certain API, a call stack of the application stores a return address to be returned to after executing the API. By using the return address, the memory address acquirer 104 acquires the memory address of the caller that called the detected API.

According to embodiments of the present disclosure, the call stack may not only include a caller that directly calls the detected API but may also include one or more higher callers of the caller. For example, when an application calls a certain subroutine and the subroutine calls an API included in a monitoring group, the call stack may not only store a memory address of the subroutine but may also store a memory address of a higher caller that called the subroutine. As such, when one or more higher callers corresponding to a caller of an API exist in a call stack, the memory address acquirer 104 may acquire a memory address of each of the one or more higher callers in addition to a memory address of the caller. As such, according to the embodiments of the present disclosure, the memory address acquirer 104 acquires all of the memory addresses of the higher callers and the caller so that the existence of a malicious code is precisely detected even when an API is called by a subroutine.

The memory attribute checker 106 checks an attribute of a memory region corresponding to a memory address acquired by the memory address acquirer 104. The attribute checked by the memory attribute checker 106 may include a type and a protection attribute of the memory region.

According to one embodiment of the present disclosure, the memory attribute checker 106 may check an attribute of a memory region by using MEMORY_BASIC_INFORMATION data structure provided by an operation system. For example, the type (AllocationProtect) of the memory region may have the below values.
PAGE_EXECUTE
PAGE_EXECUTE_READ
PAGE_EXECUTE_READWRITE
PAGE_EXECUTE_WRITECOPY
PAGE_NOACCESS
PAGE_READONLY
PAGE_READWRITE
PAGE_WRITECOPY
PAGE_TARGETS_INVALID
PAGE_TARGETS_NO_UPDATE
PAGE_GUARD
PAGE_NOCACHE
PAGE_WRITECOMBINE

In the above-described data structure, a protection attribute (Type) of the memory may have the below values.
MEM_IMAGE
MEM_MAPPED
MEM_PRIVATE

The memory attribute checker 106 may identify values of the type and the protection attribute of the memory region among the above-mentioned values based on memory information (MEMORY_BASIC_INFORMATION) corresponding to the memory address acquired by the memory address acquirer 104. In addition, the memory attribute checker 106 may check memory attributes of all of a plurality of memory addresses when the plurality of memory addresses are acquired by the memory address acquirer 104.

The determiner 108 determines whether a code written in the memory region is a malicious code based on the attribute identified by the memory attribute checker 106. According to one embodiment of the present disclosure, the determiner 108 may determine a code to be a malicious code when the memory type is an execution type (PAGE_EXECUTE*) and the protection attribute is private (MEM_PRIVATE). Specifically, the determiner 108 determines a memory type to be the execution type when the memory type is one of PAGE_EXECUTE, PAGE_EXECUTE_READ, PAGE_EXECUTE_READWRITE, and PAGE_EXECUTE_WRITECOPY.

An exploit code needs to be injected into a certain region of an application targeted for attack by an attacker process in order to execute an exploit attack. In this case, the memory region where the exploit is injected needs to be allocated by an attacker process, and therefore, the memory region has a protection attribute of MEM_PRIVATE. Also, in order for the memory region to execute a code, the region needs to have a memory type of the execution type (PAGE_EXECUTE*). Accordingly, when a memory in which an address of a code being executed is included has a protection attribute of MEM_PRIVATE and a type of PAGE_EXECUTE*, the code is determined to be a malicious code injected by an attacker.

According to one embodiment of the present disclosure, the apparatus 100 for detecting a malicious code including the monitor 102, the memory address acquirer 104, the memory attribute checker 106, and the determiner 108 may be implemented on a computing device including one or more processors and a computer readable recording medium connected to the one or more processors. The computer readable recording medium may be provided inside or outside the processor, and may be connected to the processor by various well-known means. The processor in the computing device may allow the computing device to operate according to the embodiments described in the specification. For example, the processor may execute instructions stored in the computer readable recording medium, and the instructions stored in the computer readable recording medium may allow the computing device to perform operations according to the embodiments of the present disclosure when executed by the processor.

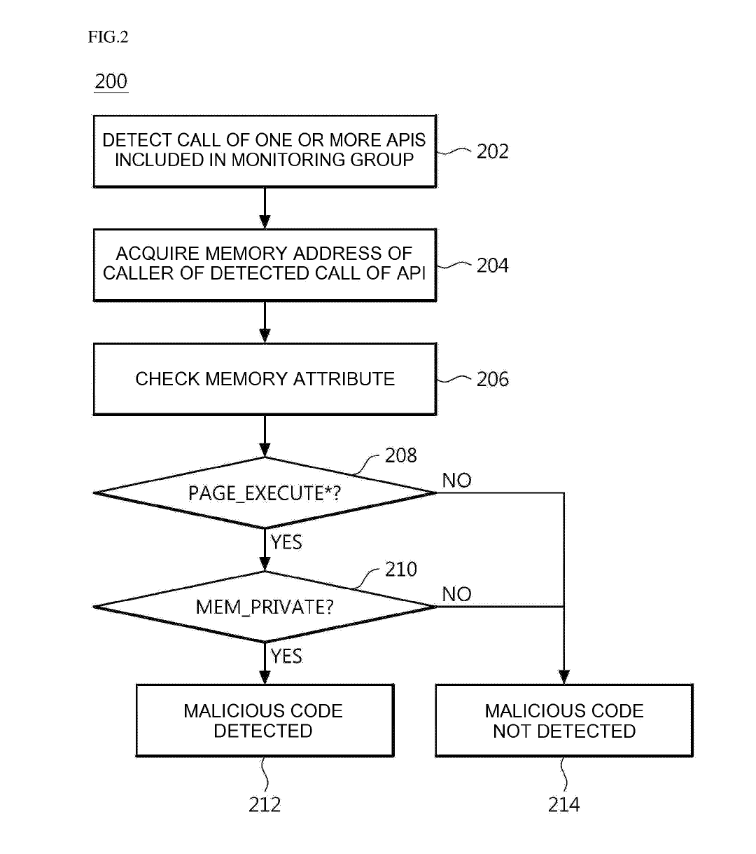

FIG. 2 is a flowchart illustrating a method for detecting a malicious code according to one embodiment of the present disclosure. The method 200 illustrated in FIG. 2 may be performed, for example, by the apparatus 100 for detecting a malicious code. Although the method will be described according to a plurality of operations in the illustrated flowchart, at least one of the operations may be performed out of the order noted in the flowchart, concurrently performed in combination with other operations, omitted, sub-divided, and or one or more additional operations which are not illustrated in the flowchart may be performed.

In operation S202, the monitor 102 of the apparatus 100 for detecting a malicious code detects a call of one or more APIs included in a monitoring group.

In operation S204, the memory address acquirer 104 of the apparatus 100 for detecting a malicious code acquires a memory address of a caller that called the API which is detected in operation S202. In this case, the memory address acquirer 104 may acquire a memory address of the caller by using a return address of a call stack associated with the call. In addition, when one or more higher callers corresponding to the caller exist in the call stack, the memory address acquirer 104 may acquire a memory address of each of the one or more higher callers in addition to the memory address of the caller.

In operation S206, the memory attribute checker 106 of the apparatus 100 for detecting a malicious code checks an attribute of a memory region corresponding to the acquired memory address. The attribute may include a type and a protection attribute of the memory region.

In operations S208 and S210, the determiner 108 of the apparatus 100 for detecting a malicious code determines whether a code written in the memory region is a malicious code based on the attribute identified in operation S206.

Specifically, in operation S208, the determiner 108 determines whether a type of the memory region is an execution type (PAGE_EXECUTE*). In operation S210, when the type of the memory region is determined to be the execution type, the determiner 108 determines whether the protection attribute of the memory region is private (MEM_PRIVATE).

In operation S212, when it is determined that the memory type is the execution type (PAGE_EXECUTE*) and the protection attribute is private (MEM_PRIVATE) in operations S208 and S210, the determiner 108 determine the code existing in the memory region to be a malicious code. However, in operation S214, when it is determined that the memory type is not the execution type (PAGE_EXECUTE*) or the protection attribute is not private (MEM_PRIVATE) in operations S208 and S210, the determiner 108 determine the code existing in the memory region not to be a malicious code.

As should be apparent from the above description, according to embodiments of the present disclosure, the existence of a malicious code is identified based on a memory attribute of a caller that called an API which is frequently used by a malicious code, and thus the existence of a malicious code can be accurately detected even in the case of an unknown malicious code.

In addition, according to embodiments of the present disclosure, all callers are traced not only when an API, which is frequently used by a malicious code, is directly called but also when the API is called via other functions so that a malicious code can be detected with high precision.

Meanwhile, exemplary embodiments of the present disclosure may include a program for performing the methods described in the specification on a computer and a computer-readable storage medium including the program. The computer-readable storage medium may include a program instruction, a local data file, a local data structure, or a combination of one or more thereof. The medium may be designed and constructed for the present disclosure, or generally used in the computer software field. Examples of the computer-readable storage medium include a hardware device constructed to store and execute a program instruction, for example, a magnetic medium such as a hard disk, a floppy disk, and a magnetic tape, an optical medium such as a compact-disc read-only memory (CD-ROM) and a digital versatile disc

(DVD), a read-only memory (ROM), a random access memory (RAM), and a flash memory. The program instruction may include a high-level language code executable by a computer through an interpreter in addition to a machine language code made by a compiler.

Although an exemplary embodiment of the present disclosure has been described for illustrative purposes, those skilled in the art should appreciate that various modifications, changes, and substitutions are possible without departing from the scope and spirit of the disclosure. Therefore, the scope of the disclosure is not limited to the embodiments but is defined in the claims and their equivalents

What is claimed is:

1. A method for detecting a malicious code, the method comprising:
detecting a call of one or more Application Program Interfaces (APIs) included in a monitoring group;
acquiring a memory address of a caller of the detected call of the API;
checking an attribute of a memory region corresponding to the acquired memory address; and
determining whether a code written in the memory region is a malicious code based on the attribute.

2. The method of claim 1, wherein the acquiring of the memory address acquires the memory address of the caller by using a return address of a call stack associated with the call.

3. The method of claim 2, wherein the acquiring of the memory address further comprises, when one or more higher callers corresponding to the caller exist in the call stack, acquiring a memory address of each of the one or more higher callers.

4. The method of claim 1, wherein the attribute includes a type and a protection attribute of the memory region.

5. The method of claim 4, wherein in the determining, the code is determined to be a malicious code when the type of the memory region is an execution type (PAGE_EXECUTE*) and the protection attribute of the memory region is private (MEM_PRIVATE).

6. The method of claim 5, wherein in the determining, the type of the memory region is determined to be the execution type when the type of the memory region is one of PAGE_EXECUTE, PAGE_EXECUTE_READ, PAGE_EXECUTE_READWRITE, and PAGE_EXECUTE_WRITECOPY.

7. An apparatus for detecting a malicious code, the apparatus comprising:
a monitor configured to detect a call of one or more Application Program Interfaces (APIs) included in a monitoring group;
a memory address acquirer configured to acquire a memory address of a caller of the detected call of the API;
a memory attribute checker configured to check an attribute of a memory region corresponding to the acquired memory address; and
a determiner configured to determine whether a code written in the memory region is a malicious code based on the attribute.

8. The apparatus of claim 7, wherein the memory address acquirer acquires the memory address of the caller by using a return address of a call stack associated with the call.

9. The apparatus of claim 8, wherein the memory address acquirer is configured to, when one or more higher callers corresponding to the caller exist in the call stack, acquire a memory address of each of the one or more higher callers.

10. The apparatus of claim 7, wherein the attribute includes a type and a protection attribute of the memory region.

11. The apparatus of claim 10, wherein the determiner is configured to determine the code to be a malicious code when the type of the memory region is an execution type (PAGE_EXECUTE*) and the protection attribute of the memory region is private (MEM_PRIVATE).

12. The apparatus of claim 11, wherein the determiner is configured to determine the type of the memory region to be the execution type when the type of the memory region is one of PAGE_EXECUTE, PAGE_EXECUTE_READ, PAGE_EXECUTE_READWRITE, and PAGE_EXECUTE_WRITECOPY.

13. A computer program stored in a computer readable recording medium combined with hardware to execute steps comprising:
detecting a call of one or more Application Program Interfaces (APIs) included in a monitoring group;
acquiring a memory address of a caller of the detected call of the API;
checking an attribute of a memory region corresponding to the acquired memory address; and
determining whether a code written in the memory region is a malicious code based on the attribute.
